(19) United States
(12) Patent Application Publication
(10) Pub. No.: US 2013/0166996 A1
(43) Pub. Date: Jun. 27, 2013

(54) Communication Method and Echo

(71) Applicants: Jorn Schrieffer, Griesheim (DE); Jurgen Scherschmidt, Frankfurt (DE); Thomas Piechl, Wollstadt (DE)

(72) Inventors: Jorn Schrieffer, Griesheim (DE); Jurgen Scherschmidt, Frankfurt (DE); Thomas Piechl, Wollstadt (DE)

(73) Assignee: Continental Teve AG & Co., oHG, Frankfurt (DE)

(21) Appl. No.: 13/816,068

(22) PCT Filed: Jul. 22, 2011
(86) PCT No.: PCT/EP11/62685

§ 371 Date: Feb. 8, 2013

(30) Foreign Application Priority Data
Aug. 3, 2010 (DE) 10 2010 038 852.1

(51) Int. Cl. G06F 11/10

(52) U.S. Cl. CPC G06F 11/1004
USPC 714/807

(57) ABSTRACT

Communication method in a communication system comprising a first communication unit (A) and a second communication unit (B) which are connected to one another via at least one first communication path, wherein the first communication unit (a) transmits at least one first message or a first command to the second communication unit (B), which message or command comprises at least one item of address information (ADDR) according to which the second communication unit (B) transmits a first response message to the first communication unit in response to the first message or the first command, wherein this first response message comprises at least one item of data information (DAT) and additionally the address information relating to the first command itself (ADDR) or an item of information (CRC) derived from this address information.

### CROSS-REFERENCE TO RELATED APPLICATION

This application claims priority to German Patent Application No. 10 2010 038 852.1, filed Aug. 3, 2010 and PCT/EP2011/062685, filed Jul. 22, 2011.

### FIELD OF THE INVENTION

This invention relates to a communication method and communication.

### INITIAL DESCRIPTION OF THE INVENTION

The present invention has the object of proposing a communication method and a corresponding communication system which are suitable for safety-critical applications.

According to the invention, this object is achieved by the and the electronic communication system as described herein.

A digital message often has at least one or more data words (bytes) and one or more command words and/or at least one address word, these words being, in particular, data which have a defined relationship within the message.

A derived information item is preferably understood to be a dependent information item or an information item dependent due to data processing-related and/or mathematical steps.

The first communication unit and the second communication unit are preferably connected to one another by means of precisely one data line as a communication path.

The first communication unit preferably sends at least one first message or one first command to the second communication unit, which has at least one address information item and/or one command information item. In particular, the first command or the first message additionally has a data information item. It is appropriate that this first command additionally includes a test information item which depends at least partially on the address information and/or command information, that is to say is redundant with respect to the address information and/or command information and especially additionally with respect to the command information.

The second communication unit sends, as a response to the first message or the first command, preferably a first response message, especially directly or immediately, to the first communication unit. This first response message comprises preferably data information and additionally the address information and/or command information of the first command itself or an information item dependent thereon or derived therefrom, this information dependent on the address information and/or command information of the first command being formed especially as part of a test information item.

The address information and/or the command information and/or the data information and/or the test information are suitably formed in each case as a data block within the data word of the corresponding message or of the corresponding command or of the corresponding response message.

It is preferred that within the response message of the second communication unit, the information derived from the address information and/or command information of the first command is formed as part of a test information item.

It is preferred that the first message or the first command of the first communication unit additionally includes a test information item which is derived at least partially from the address information and/or command information, that is to say is redundant with respect to the address information and/or command information.

It is appropriate that the test information of the first command or of the first message and/or of the first response message is formed as correction information, the code of which has a corresponding or defined minimum Hamming distance.

The test information of the first command or of the first message and/or of the first response message is preferably formed as a cyclic redundancy check or CRC.

It is preferred that the first response message is formed in such a manner that the address information and/or command information of the first message or of the first command is coded at least partially into the first response message.

It is suitable that the first response message contains additionally at least a part of the data information redundantly, that is to say transmits, for example, one or more error bits and/or status bits directly and additionally dependently thereon, especially inverted.

It is preferred that the response message includes a part of the data information multiply redundantly, at least once redundantly in the data information itself and included in the test information.

It is suitable that each message or each command, respectively, of the first communication unit to the second communication unit, which contains an address information item and/or a command information item, is answered by the second communication unit with a response message in accordance with the first response message.

The invention also relates to the use of the electronic communication system in motor vehicles.

### BRIEF DESCRIPTION OF THE DRAWINGS

In a diagrammatic representation,

FIG. 1 shows an exemplary communication in two variants a) and b) between the first communication unit A and second communication unit B, wherein the first communication unit A transmits a first command 1 to the second communication unit B and the latter responds thereto with a first response message 2, 3, and

FIG. 2 shows an alternatively exemplary first response message 4, 5 of the second communication unit B to the first communication unit A in response to a first message or a first command according to FIG. 1 a) and b).

### DETAILED DESCRIPTION OF THE INVENTION

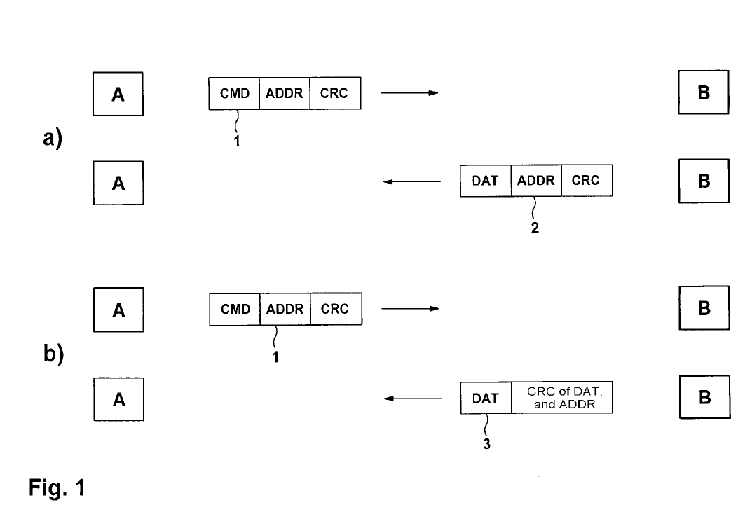

In the context of the present invention with particular reference to FIG. 1, data word 1, as a first message or first command of the first communication unit A, includes a command data block CMD with a command information item, an address data block ADDR with an address information item, and a test data block CRC with a test information item, dependent on CMD and ADDR, formed as a cyclic redundancy check.

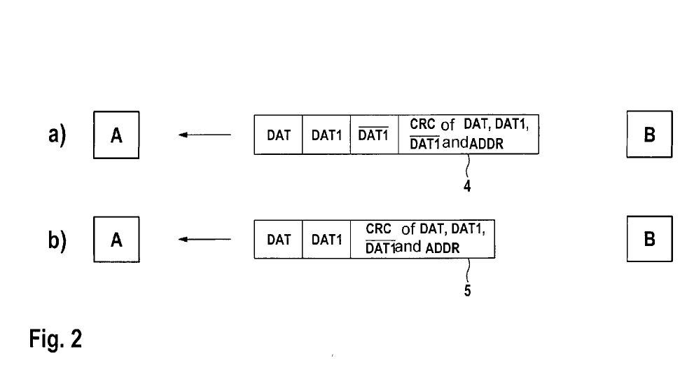

Data words 2, 3, 4, 5 as in each case exemplary first response message of the second communication unit B includes a data word DAT with a data information item. Data word 2 from FIG. 1 a) has additionally the address data block ADDR with the address information of the first message 1 of the communication unit A as a type of repetition or echo and a test data block CRC, dependent on DAT and ADDR, formed as a cyclic redundancy check. Data word 3 from FIG. 1 b) has additionally to the data word DAT only one test data block CRC which is coded dependently on DAT and dependently on the address information of the first command. In FIG. 2a), the data word 4 has additionally to the data word DAT also a further redundant data information item, for example an error and status information item, as redundant data words DAT1 and D̅A̅T̅1̅, coded inverted with respect to one another, and a test data block CRC which is coded dependently on DAT, DAT1, D̅A̅T̅1̅ and dependently on the address information of the first command, for example formed as a cyclic redundancy check. Based on data word 4, data word 5 from FIG. 2 b) only has DAT and DAT1 and test data block CRC which in this case is also coded dependently on DAT, DAT1, D̅A̅T̅1̅ and dependently on the address information of the first command, for example also formed as cyclic redundancy check.

According to the example, the redundant data words DAT and DAT1 are data words having similar or essentially identical information content which are provided from two test paths of a sensor, these two test paths being designed redundantly and therefore supplying similar information.

While the above description constitutes the preferred embodiment of the present invention, it will be appreciated that the invention is susceptible to modification, variation and change without departing from the proper scope and fair meaning of the accompanying claims.

1. A communication method for use in a communication system comprising the steps of providing a first communication unit (A) and a second (B) communication unit which are connected to one another via at least one first communication path, wherein the first communication unit (A) sending at least one of a first message or a first command to the second communication unit (B), wherein the first message or the first command having at least one of an address information item (ADDR) and a command information item (CMD), and thereafter the second communication unit (B) sending, as a response to the first message or the first command, a first response message to the first communication unit, wherein the first response message having a data information item (DAT) and at least one of the address information item (ADDR), the command information item (CMD) and a test information item (CRC) derived from the address information item or the command information item (CMD).

2. The communication method as claimed in claim 1, further comprising connecting the first communication unit (A) and the second communication unit (B) to one another by means of a single data line as the first communication path.

3. The communication method as claimed in claim 1, further comprising in that within the first response message of the second communication unit (B), deriving from at least one of the address information (ADDR) and the command information item (CMD) of the first command the test information item (CRC).

4. The communication method as claimed in claim 1 further comprising in that the first message or the first command (1) of the first communication unit (A) including the data information item (DAT).

5. The communication method as claimed in at least claim 1 wherein in that the first message or the first command of the first communication unit (A) further comprises the test information item (CRC) which is derived at least in part from the address information item (ADDR) or the command information item (CMD), and is thereby redundant with respect to the address information item or the command information item (CMD).

6. The communication method as claimed in claim 1 further comprising in that the test information item (CRC) of the first command or of the first message or of the first response message is formed as correction information, the code of which has a corresponding minimum Hamming distance.

7. The communication method as claimed claim 1 further comprising in that the test information item (CRC) of the first command or of the first message or the first response message is formed as a cyclic redundancy check (CRC).

8. The communication method as claimed in claim 1 further comprising in that the first response message is formed in such a manner that the address information item (ADDR) or the command information item (CMD) of the first message or the first command is coded at least partially into the first response message.

9. The communication method as claimed in claim 1 wherein the first response message further comprising at least a part of the data information item (DAT1) redundantly, and transmitting one or more error bits or status bits directly and additionally dependently thereon.

10. The communication method as claimed in claim 1 wherein the response message further comprises a part of the data information item multiply redundantly (DAT1, D̅A̅T̅1̅, CRC), at least once redundantly (DAT1) and included in the test information item (CRC).

11. The communication method as claimed in at least claim 1 in that for every one of the message or the command of the first communication unit (A) sent to the second communication unit (B), which contains an address information item (ADDR) or a command information item (CMD), is answered by the second communication unit (B) with the response message.

12. An electronic communication system comprising a first (A) and a second (B) communication unit which are connected to one another via at least one first communication path, the communication system configured to execute a communication method wherein the first communication unit (A) sending a first message or a command to the second communication unit (B), wherein the first message or the first command having at least one of an address information item (ADDR) and a command information item (CMD), after which the second communication unit (B) sending, as a response to the first message or the first command, a first response message to the first communication unit, wherein the first response message having a data information item (DAT) and at least one of the address information item and the command information item (CMD) of the first command (ADDR) or a test information item (CRC) derived from the address information item or the command information item (CMD).
